(19) United States
(12) Patent Application Publication
(10) Pub. No.: US 2022/0151170 A1
(43) Pub. Date: May 19, 2022

(54) GROUND SURFACE CONDITION SENSING IN IRRIGATION SYSTEMS

(71) Applicants: AGRESEARCH LIMITED, Lincoln (NZ); AUCKLAND UNISERVICES LIMITED, Auckland (NZ)

(72) Inventors: Valerie Olga SNOW, Lincoln (NZ); Stuart George BRADLEY, Auckland (NZ); Chandra Prasad GHIMIRE, Lincoln (NZ)

(73) Assignees: AGRESEARCH LIMITED, Lincoln (NZ); AUCKLAND UNISERVICES LIMITED, Auckland (NZ)

(21) Appl. No.: 17/430,813

(22) PCT Filed: Feb. 14, 2020
(86) PCT No.: PCT/NZ2020/050013

§ 371 Date: Aug. 13, 2021

(30) Foreign Application Priority Data
Feb. 15, 2019 (NZ) 750742
May 30, 2019 (NZ) 754059

(51) Int. Cl. A01G 25/16; G01N 29/07; G01N 29/11; G10K 11/34; G01V 1/00

(52) U.S. Cl. CPC A01G 25/167; G01N 29/07; G01N 29/11; G10K 11/346; H04R 2201/403; G01N 2291/02845; G05B 2219/2625; G05B 2219/37433; G01V 1/001

(57) ABSTRACT

Optimising water use in a way that avoids over watering or at least avoids or minimises water mobilisation may be useful. An irrigation control system is described, the system including a sound emitter arranged to emit sound towards a ground surface; a sound receiver arranged to receive sound emitted by the sound emitter and reflected or scattered from the ground surface. A controller then controls one or more irrigation parameters of an irrigator based at least in part on sound received by the sound receiver. In a further aspect, the irrigation control system senses the onset of surface water pooling or free water flow on the ground surface and the controller then controls irrigation parameters to reduce application of water in response to the sensed features. Related methods of controlling irrigation systems are also described.

### RELATED APPLICATIONS

This application derives priority from New Zealand patent application number 750742 dated 15 Feb. 2019 and New Zealand patent application number 754059 dated 30 May 2019 both incorporated herein by reference.

### TECHNICAL FIELD

Sensing of ground surface conditions in irrigation systems and related control systems and methods are described herein, particularly but not exclusively, to the sensing of moisture and/or surface water.

### BACKGROUND

Food production in agriculture and horticulture is often dependent on irrigation. Economically, the irrigated agriculture sector is increasingly important. For example, irrigated soils are believed to produce nearly 30% of the world's food. The area of irrigated agriculture in New Zealand has rapidly increased in the past 20 years and is now believed to produce nearly 20% of New Zealand's agricultural GDP.

Farmers face competing financial incentives with respect to irrigation water usage. The water is a significant production input cost, but under-watering will reduce yield leading to reductions in revenue. This tends to encourage over-watering.

Irrigated agriculture can also cause environmental harm by mobilising pollutants so that they can move directly into waterbodies, causing water quality degradation. Mobilisation of pollutants happens when the irrigation rate is greater than a critical rate at which the soil can accept water. This may be a point at which water infiltration into soil can no longer be fully supported. The ground surface conditions that lead to free surface water accumulating during irrigation vary strongly and unpredictably in space and time. Such variation defeats many current irrigation systems, which generally rely on static soil properties and average conditions. Good irrigation design can only partially address this issue.

Variable rate irrigation combined with spatial information such as soil maps created at the time of commissioning allows variable amounts of water to be applied to different areas. However, being based on a one-off or irregular assessment of soil, this does not provide accurate or reliable limitation of water application.

As may further be appreciated, similar considerations may apply to irrigated effluent in that over-irrigation may result in pooling and mobilisation of effluent applied to the ground. This again is detrimental to the environment.

It would be desirable to limit excessive application of water in irrigation systems, or at least to provide the public with a useful choice.

### SUMMARY

In one aspect, an irrigation control system may include: a sound emitter arranged to emit sound towards a ground surface; a sound receiver arranged to receive sound emitted by the sound emitter and reflected or scattered from the ground surface; and a controller configured to control one or more irrigation parametres of an irrigator based at least in part on sound received by the sound receiver.

The sound emitter may be a directional sound emitter, arranged to emit a directional sound beam. The sound emitter may be an omni-directional emitter. The directional sound emitter may be arranged to emit a sound beam with a half power beam width in the range 4 to 60 degrees. The directional sound emitter may be arranged to emit a sound beam with a half power beam width around 8 to 45 degrees. The directional sound emitter may be arranged to emit a sound beam with a half power beam width 4, or 5, or 6, or 7, or 8, or 9, or 10, or 15, or 20, or 25, or 30, or 35, or 40, or 45, or 50, or 55, or 60 degrees.

The directional sound emitter may be arranged to emit a sound beam having a projected area at the ground surface in the range 0.03 to 1.8 square metres. The directional sound emitter may be arranged to emit a sound beam having a projected area at the ground surface of around 0.2 square metres. The directional sound emitter may be arranged to emit a sound beam having a projected area at the ground surface of around 0.03, or 0.04, or 0.05, or 0.06, or 0.07, or 0.08, or 0.09, or 0.1, or 0.2, or 0.3, or 0.4, or 0.5, or 0.6, or 0.7, or 0.8, or 0.9, or 1.0, or 1.1, or 1.2, or 1.3, or 1.4, or 1.5, or 1.6, or 1.7, or 1.8 square metres. The directional sound emitter may include an array of sound emitting elements.

A direction of the directional sound beam may be controllable.

The directional sound emitter may include a controllable phased array of sound emitting elements.

The sound emitter may be configured to emit sound with a frequency in the range 0.5 to 4.5 kHz. The sound emitter may be configured to emit sound with a frequency from 2 to 4.5 kHz. The sound emitter may be configured to emit sound with a frequency of around 0.5, or 0.6, or 0.7, or 0.8, or 0.9, 1.0, or 1.5, or 2.0, or 2.5, or 3.0, or 3.5, or 4.0, or 4.5 kHz.

The sound emitter may be configured to emit sound in the form of sound pulses. The sound emitter may be configured to emit sound in the form of sound pulses with a pulse duration in the range 0.5 to 10 ms. The sound emitter may be configured to emit sound in the form of sound pulses with a pulse duration of around 0.5, or 0.6, or 0.7, or 0.8, or 0.9, or 1.0, or 2, or 3, or 4, or 5, or 6, or 7, or 8, or 9, or 10 ms. The sound emitter may be configured to emit sound in the form of sound pulses with a pulse duration of around 1 ms.

The sound emitter may be configured to emit sound embodying a coded signal.

The sound receiver may be a microphone. The sound receiver may be a microphone array. The sound receiver may be a directional microphone array. The sound receiver may be omni-directional.

The sound receiver may be a microphone phased array having a controllable sensing direction.

As may be appreciated from the above, the sound emitter or receiver may be a single emitter or receiver or multiple emitters and/or receivers. For ease of description reference is generally made below to a single emitter or receiver however this should not be seen as limiting and reference to the singular may be to plural or vice versa.

The controller may be configured to control the one or more irrigation parameters to reduce or prevent water application when the sound received by the sound receiver is indicative of the presence of surface water.

The controller may be configured to control the one or more irrigation parameters to reduce or prevent water application when a change in the sound received by the sound receiver is indicative of the onset of the presence of surface water.

The controller may be configured to control the one or more irrigation parameters using information from one or more acoustic sensors to reduce or prevent water application when a change in the sound received by the sound receiver(s) is indicative of the onset of the presence of surface water.

The one or more irrigation parameters may include a water application rate.

The one or more irrigation parameters may include valve on/off status.

The one or more irrigation parameters may include valve pulsing and/or valve pulse rate.

The one or more irrigation parameters may include varying irrigation boom speed and/or varying irrigation intensity.

The irrigation control system may include a positioning system configured to determine a position of the irrigator and/or sensor in real time.

The irrigation control system may be configured for continuous or periodic emission and detection of sound.

An irrigation system may include an irrigation control system as described above and one or more irrigators arranged to supply water to the ground surface.

The one or more irrigators may include one or more moving irrigators. The sound emitter(s) and sound receiver(s) may be mounted on the moving irrigator.

The controller may be configured to control the one or more irrigation parameters of the one or more irrigators based, at least in part, on sound received by the sound receiver in real time.

The water referred to above may be fresh water, grey water, water used in agriculture, irrigation sources, effluent and other substantially water-based streams capable of irrigation or broadcast to the ground.

A method of controlling an irrigation system may include: emitting sound towards a ground surface; receiving sound emitted by the sound emitter and reflected or scattered from the ground surface; and controlling one or more irrigation parameters of an irrigator, based at least in part, on sound received by the sound receiver.

An irrigation control system may include: a sensor arrangement configured to sense the onset of surface water pooling or, the onset of free water flow on the ground surface; and a controller configured to control one or more irrigation parameters of an irrigator to reduce application of water in response to the sensing of the onset of surface water pooling or, the onset of free water flow on the ground surface, or a trend in water coverage, or a value of water connectivity.

### BRIEF DESCRIPTION OF THE DRAWINGS

Sensing of ground surface conditions in irrigation systems and the control systems and methods will be described by way of example only, with reference to the accompanying drawings, in which:

FIG. 1 illustrates one embodiment of an acoustic sensing arrangement;

FIG. 2 illustrates another embodiment of an acoustic sensing arrangement;

FIG. 3 shows the arrival time of direct and reflected sound pulses in the arrangement of FIG. 2;

FIG. 4 shows a simulated combined direct and reflected signal from the central speaker in the arrangement of FIG. 2, for a 13 segment Barker code at 4100 Hz;

FIG. 5 shows the signal of FIG. 4, after application of a matched filter;

FIG. 6 shows a signal measured using a 13-segment Barker code at a frequency of 3300 Hz (circles) and a fitted curve (solid line);

FIG. 7 shows the theoretical beam pattern for the M=7 speaker array at frequencies of 1 kHz and 3 kHz;

FIG. 8 shows the measured beam pattern compared with theoretical at 3.4 kHz and a zero progressive time delay between speakers;

FIG. 9 shows normalised acoustic ground impedance as a function of frequency;

FIG. 10 shows reflectivity as a function of incident angle;

FIG. 11 shows the layout used in the experiment undertaken of the phased array of speakers (at left), the sample tray (centre), and the single microphone (right);

FIG. 12 shows the normalised (against the relevant dry soil value) microphone output at selected frequencies in the range 0.5 kHz to 3.9 kHz versus water added to the soil sample;

FIG. 13 shows a schematic diagram of the field experimental set up of Example 6;

FIG. 14 shows the relative acoustic power of the correlated outputs for a range of frequencies and for the least-saturated and most-saturated soil surfaces;

FIG. 15 shows a schematic diagram of the second field experimental set up with the dimensions;

FIG. 16 shows the relative acoustic power using a 13-step Barker code for 3.3 kHz (Filling);

FIG. 17 shows the relative acoustic power using the reverse process to FIG. 16, where initially all the soil surface depressions were connected and filled with water, and at the final stage water was slowly drained from the soil tray over time leaving a wet soil surface using a 13-step Barker code for 3.3 kHz (Emptying);

FIG. 18 shows a schematic diagram of the field experimental set up used in Example 8;

FIG. 19 shows the relative acoustic power measurements obtained for frequencies 2.5 kHz-4.5 kHz with a 0.4 kHz step conducted over uncut pasture and pasture cut to close to the ground;

FIG. 20 shows a schematic diagram of the field experimental set up used in Example 9; and

FIG. 21 shows changes in relative acoustic power for 3.3 kHz frequency when the runoff plot was slowly filled in with effluent.

### DETAILED DESCRIPTION

As noted above, it may be useful to optimise water management and in particular avoid the risk of water mobilisation. Irrigation control systems and methods of use are described herein to at least address or mitigate this problem.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ or grammatical variations thereof refers to at least about 50%, for example 75%, 85%, 95% or 98%.

The term ‘comprise’ and grammatical variations thereof shall have an inclusive meaning—i.e. that it will be taken to mean an inclusion of not only the listed components it directly references, but also other non-specified components or elements.

In some embodiments, the aspects described herein may provide detection of water on the ground surface. This allows the irrigation system to be controlled to limit excessive application of water. Free water on the ground surface is not bound to the soil surface but is instead free to flow into water bodies, potentially carrying with it a range of pollutants (e.g. nitrogen, phosphorus, sediment, faecal bacteria and other microorganisms). Free water results from the soil no longer being able to absorb the water applied, i.e. the water no longer fully infiltrates the ground. By reducing the amount of pooled or free water on the ground surface during irrigation, the Applicant's system may reduce water waste and negative environmental effects such as the run-off of nutrients into water ways.

In some embodiments, the aspects described may provide real-time evaluation of the rapidly-evolving soil surface conditions which trigger bypass flow and runoff. This allows real-time control of irrigation in accordance with current ground surface conditions.

The aspects described may utilise the acoustic properties of the ground surface. In some embodiments the system will detect acoustic reflectance values, or changes in those values. In further embodiments the system may detect phase shifts in the reflected signal.

The Applicant's acoustic reflection arrangement offers a non-intrusive method to sense the condition of the soil surface. Directional sound waves may be emitted from a sound emitter, to penetrate the pasture or crop cover, before being reflected by the soil surface. Depending on the condition of the soil surface, the reflected sound has altered properties (e.g. amplitude and/or frequency and/or phase) compared to that emitted. Therefore, measurement of the changes in properties of the reflected sound allows an assessment of the condition of the soil surface. Additionally, direct sound may be used as a reference.

The Applicant's system may combine an elevated acoustic source, receiver and smart signal processing. Moreover, acoustic reflection may achieve high-frequency, spatially-integrated measurements of the soil surface condition allowing real-time (i.e. during the irrigation event itself) control of irrigation inputs.

By fitting the Applicant's system in new irrigation systems, or by retrofitting it in existing irrigation systems, irrigation controllers may respond to soil surface conditions that vary unpredictably in space and time, and which are a primary cause of water wastage and nutrient and microorganism flows into water bodies. The generation of free water is the result of a fine balance between the irrigation rate and the rate at which the soil can transport water away from the surface (also called the rate of infiltration). This is strongly influenced by soil conditions that vary strongly in space and time, affected by many farm operations including grazing and cultivation. In some conditions, free water may be generated even though the deeper soil is dry. The Applicant's system detects free water regardless of the underlying soil conditions.

Advantageously, the Applicant's system does not require installation of sensors in the ground or physical contact of sensors with the ground surface. This may be particularly useful since such sensors can be sensitive to environmental conditions e.g. dirt, and it allows a much wider breadth of area of ground to be sensed and hence removes any localised anomalies.

Directional beams of sound may be used. Sound beams may pass through pasture before being reflected by the soil surface. In some embodiment's, corrections for the level of pasture cover may be used. Pasture cover may be measured using any suitable existing technology, including plate metres, optical measurements etc. Corrections may also be made for slope and/or soil surface conditions prior to irrigation. The presence of even quite substantial amounts, at least up to 3500 kg dry matter per hectare, of pasture on soil were found to not confound the results.

In some embodiments pulsed sound may be transmitted, with a pulse duration in the range of 0.5 to 10 ms, preferably around 1 ms.

The soil surface may alter the properties of the sound and that alteration may be detected using one or more focussed microphones and signal-processing software. A plurality of microphone elements may be arranged in a linear or 2D or 3D array, providing enhanced directionality as for the speaker array. Signal processing may be used to provide selected delays between signals received from each microphone, before adding the signals together. This may be useful to provide for scanning in the microphone direction and may be used to observe a range of reflectance angles.

The alteration in sound from the soil surface may also depend on the ground surface conditions.

Acoustic reflection has the advantage of not requiring contact with the soil. Therefore, the apparatus can be moved with the irrigation system. In some embodiments the sound emitters and detectors may be mounted on a moving irrigator. For example, sound emitters and detectors may be mounted directly to existing irrigator booms, pipes or droppers. Alternatively, sound emitters and detectors may be mounted on supports, such as masts or droppers, or attached to the irrigator for the purpose, or may not be attached to the irrigator system and instead linked via an independent support structure.

The sensor(s) may be coupled with a controller that may convert information from the sensor(s) into an action for the irrigation system such as to cease irrigation or to reduce the application rate (e.g. by pulsing one or more valves and/or sprinklers, varying the velocity of the irrigator, or some other mechanism). In general, any irrigation parameter (including any parameter of the irrigation system) may be controlled in order to cease irrigation or to reduce the application rate.

The controller may self-learn to anticipate the occurrence of free water using a combination of the information from the sensor plus a history of previous behaviour at the same site.

In some embodiments, the system may exclude the effects of ambient noises (e.g. the background noise from the irrigation system, and potentially from other farm machinery). For example, a coded signal or a unique acoustic signature (a ‘chirp’) may be emitted from the transmitter and detected by the detector. The acoustic signal may be a short duration pulse (e.g. 20 ms) in which the frequency is swept in time to form a ‘chirp’. Comparison of the received signal with the transmitted signal gives very good travel time estimation and good noise rejection. The acoustic signal may conceivably be akin to a sound or group of sounds different to other noise in the environment. The sound need not be particularly loud to produce an accurate reading. The sound may be sufficiently soft or inconspicuous as to barely be noticed by people in the surrounding environment.

Further, the received signal may be compared with versions of the transmitted chirp with frequency-dependent amplitude changes. In this way, the frequency dependence of the reflectivity may be obtained while simultaneously providing good signal-to-noise in an environment with significant ambient noise e.g. road noise, irrigation noise etc.

Alternatively, signal processing techniques may be used to exclude ambient noise. These may include suitable spectral filtering or signal coding techniques.

The signal may be selected from a sinusoidal pulse, a barker code, a two-signal tone or a tonal pulse. A 13-step Barker code appears to work well based on the applicants' preliminary work.

In further embodiments, frequency dependence of the acoustic properties may be assessed by the use of multiple frequency sources, or by scanning the emitted frequency over a frequency range.

In general, the soil surface may be naturally rough but, may begin to smooth out as the small pockets of water (perhaps 20-50 mm across) develop during an irrigation event, filling hollows in the surface. When these pockets of water are isolated from each other, they do not create run-off of excess water. However, when the pockets coalesce to form connected flow pathways, the water can begin to move from the point of application. This is when water efficiency is lost and environmental harm caused or potentially caused. At the very least, mobilised water represents wasted water.

Further, the transition from rough to smooth also presents a change in acoustic properties. When those pockets of water coalesce the soil surface may be detected as being smoother by the acoustic reflection sensor. This transition may be detected by monitoring the acoustic properties of the surface. The conditions of the ground surface may be assessed using individual measurements or by monitoring the measurements over a time period and looking for changes or transitions in those measurements.

In one embodiment, the reflection coefficient may be greater than 0.85 for pooled water and less than 0.85 for ground. As should be appreciated however, the exact reflection coefficient may be variable depending on the input frequency and incident angle.

Propagation of sound outdoors, including ground surface acoustic reflectance, has been studied in the context of noise annoyance from industries, traffic, and airports over relatively long distances at low heights, mostly at frequencies below 2 kHz. Semi-empirical models of sound propagation depend on acoustic flow resistivity, and other parameters such as soil porosity. The acoustic flow resistivity is a measure of the air space volume in the soil near the surface with sound propagation being limited to a depth of around 10 mm. The near-surface nature of the acoustic interaction is beneficial for the purposes of sensing the presence of free water on the soil surface. Measurable properties include a reflection coefficient and absorption, which depend on the complex ground impedance and the angle of incidence. At sound frequencies below 1 kHz, flow resistivity has the largest effect on impedance, and above 1 kHz porosity is more evident. In some embodiments of the Applicant's system, the sound employed may be in the frequency range of 0.5-4.5 kHz to capture dependency on both parameters. Sound at around 2 to 3 kHz may be used.

At acoustic frequencies below about 4 kHz the ground surface may not act as a rigid reflector. The amplitude and phase of the reflected sound may be dependent on the acoustic properties of the surface, such as sound speed and absorption. In particular, the acoustic properties of soil and water are distinct.

There have been attempts to identify soil moisture effects on sound propagation. One study indicates that reflectance measurements have potential to give estimates of volumetric water content. (See Mohamed, M. H. A. & Horoshenkov, K. V. Airborne acoustic method to determine the volumetric water content of unsaturated sands. J. Geotech. geoenvironmental Eng. 135, 1872-1882 (2009); Horoshenkov, K. V & Mohamed, M. H. A. Experimental investigation of the effects of water saturation on the acoustic admittance of sandy soils. J. Acoust. Soc. Am. 120, 1910-1921 (2006); and Cramond, A. J. & Don, C. G. Effects of moisture content on soil impedance. J. Acoust. Soc. Am. 82, 293-301 (1987).) However, these studies are not concerned with the analysis of the ground surface condition, nor with the detection of free water. Furthermore, these studies have been concerned with the low-angle propagation of sound over the ground, rather than the properties assessed in the Applicant's methods, e.g. higher-angle reflectance properties.

As noted above, reflectance depends on angle of incidence. Further, it is beneficial to know where on the ground surface the reflections are occurring. The system may therefore employ a directional sound emitter. In one embodiment an array of emitter elements may be used. The use of a linear or 2D or 3D array of transmitting elements allows for a sound beam of enhanced directionality. This is because the transmissions from the multiple sources have the same path length to the ground only in the forward direction, and so only add constructively in this direction.

Further, the phase of sound emitted by each of the elements can be phased to set or to adjust the beam direction. In one embodiment the phases may be controlled to scan the beam direction and therefore the reflection point across the ground surface. By sending signals with appropriately selected time delays between transmitting elements, the direction of constructive addition of transmission may be changed dynamically and electronically. The angle of incidence on the ground may therefore be changed so as to make use of detection of angular variations in sound scattering from the surface.

Any suitable phased array may be used—see for example Legg, M. & Bradley, S. A combined microphone and camera calibration technique with application to acoustic imaging. IEEE Trans. image Process. 22, 4028-4039 (2013); and Bradley, S. Atmospheric Acoustic Remote Sensing. DOI: 10.12, (CRC Press, 2007).

Any other suitable sound emitter may be used. For example, parametric transmitters may produce highly directional sound.

Directional sound emitters may have a half power beam width in the range of 4 to 20 degrees, and preferably around 8 degrees. Alternatively, the sound emitters may be arranged to form a “spot” or projected area on the ground of around 0.2 to 1.5 square metres, preferably around 0.5 square metres.

Multiple distinct acoustic sensing arrangements may be distributed in space. For example, multiple distinct acoustic sensing arrangements may be distributed along the length of a moving centre-pivot irrigator.

Further, a parametric array could be used, operating with ultrasonic frequencies near 40 kHz, which will mix to produce sound at the desired 1 kHz. This method may allow use of a transmitting array of diameter around 85 mm, while obtaining a half-power beam-width of around 6°. For a transmitter height of 0.5 m (for example), this may give a ‘spot size’ of diameter about 150 mm (or area around 0.02 square metres) on the ground surface.

In further embodiments, a plurality of, or multiple test ‘spots’ may be used within a single assessment area. This may allow the development of unconnected small surface pools to be observed in real time. As noted above, the formation and coalescence of small pools may be important in assessing the formation of free water on the ground surface. To achieve this, multiple sound beams may be used with multiple detectors. Alternatively, a single sound beam may be spatially scanned (whether mechanically or by adjustment of phase in a phased array) over the ground surface. The scanned beam may be detected by multiple detectors or by a suitably steered phased detector array.

Examples of possible acoustic setups will now be described.

### EXAMPLE 1

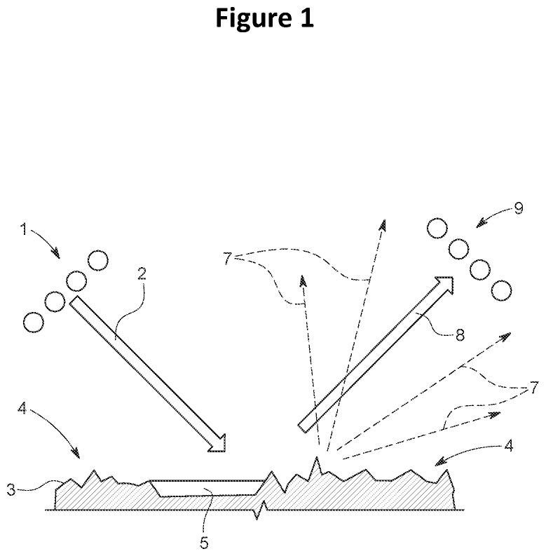

FIG. 1 is a schematic view illustrating the general arrangement of sound emitters and detectors in one embodiment. One or more speaker arrays 1 (or any other suitable emitters) may be arranged to emit a directional sound beam, indicated by arrow 2, towards the ground surface 3. For illustrative purposes the ground surface 3 is shown as including rough areas 4 and a region of pooled water 5. Sound incident upon the rough areas 4 will form diffuse reflected sound as indicated by dashed arrows 7. However, sound incident upon the pooled water surface will be more strongly reflected (i.e. in a mirror-like or specular reflection, as indicated by arrow 8) and will be detected by one or more detectors 9.

The propagation time for the reflected sound (i.e. from emitter to detector) may be around 6-7.5 ms in some embodiments, though this will depend on the layout of emitters and detectors, and is not critical. Four or more reflectance spots may be sampled continuously or periodically, typically ten times per second, giving good temporal and spatial resolution.

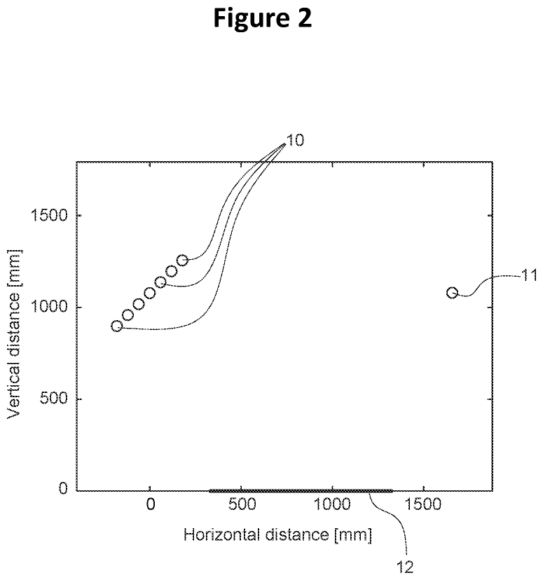

FIG. 2 shows a further arrangement, in which a speaker array (with the individual speaker elements indicated by circles 10) may be mounted at around 45° to the horizontal. A single microphone 11 may be mounted generally at a similar height to the speaker array.

### EXAMPLE 2

The arrangement of FIG. 2 was tested outdoors by placing an earth-filled pan at height 0, indicated by line 12 in FIG. 2. The water level in the pan could be adjusted. On a frame above these items a downward facing 3D structured light camera viewed the earth-filled tray, so that its topology could be recorded, including any pooled water. To one side of the array-microphone line a GoPro camera also recorded the earth in the tray.

Sinusoidal pulses of various frequencies and of duration 10 ms were generated and directed toward the earth-filled pan. There are multiple paths to the microphone from each of the 7 speakers: directly across the space between speaker and microphone; and bouncing off the soil and surrounding platform and then back upward to the microphone. Acoustic foam helped reduce the reflections from the platform.

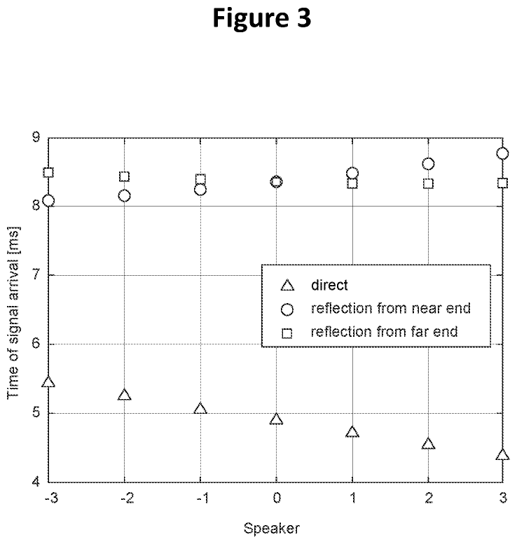

FIG. 3 shows the timing of the first arrival at the microphone of the signals from each of the seven speaker elements and for each of the three paths. The direct signals arrive first (shown in triangle symbols), and the signals reflected from either the nearest edge of the pan (circle symbols) or the furthest edge of the pan (square symbols) arrive in a bunch together.

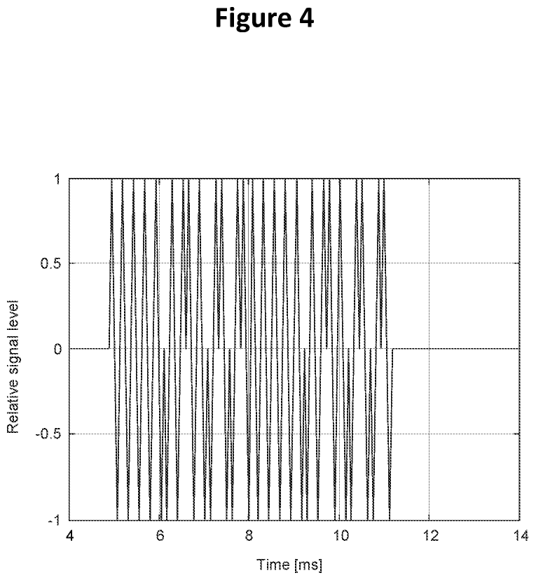

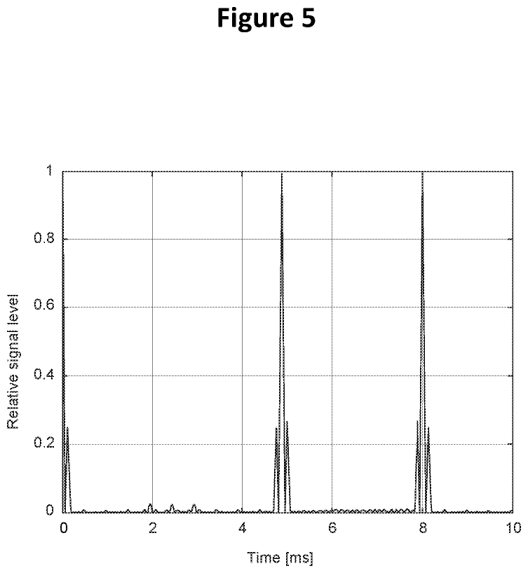

FIG. 4 shows the resulting combined direct and reflected signal from the central speaker of FIG. 2, for a 13-segment Barker code at 4100 Hz. FIG. 5 shows the signal of FIG. 4 after application of a matched filter, with the peaks corresponding to direct and reflected signals.

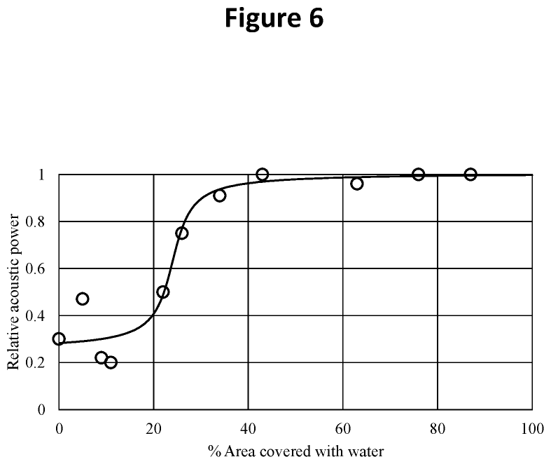

The results of the testing are summarised in FIG. 6, which shows a signal measured using a 13-segment Barker code at a frequency of 3300 Hz (circles) and a fitted curve (solid line). The relative acoustic power shows a marked increase between about 20% and 40% of surface area filled by surface water.

FIG. 6 shows that there is a clear and consistent demarcation between the pooled water case and the case of wet, un-pooled earth.

There appears to be good separation between wet earth without pooling and wet earth with pooled surface water.

### EXAMPLE 3

In this example the theoretical aspects of the acoustic system described are explored.

In a first experiment completed, an acoustic array antenna was used of length 0.8 m. The ‘far field’ region (Fresnel parameter>1) for this antenna is beyond a range of about 1 m at a frequency of 4 kHz. In the laboratory setup used in the experiment, the distance between the array center to the center of the tray holding the target soil surface was 1.56 m (2.6 array diameters). Thus, the “far field” approximations can be used. The tray subtends an angle of about ±4° at the array.

A linear array of regularly and closely spaced seven super-horn speakers was constructed. This geometry can be described by M omni-directional speakers having spacing (20):

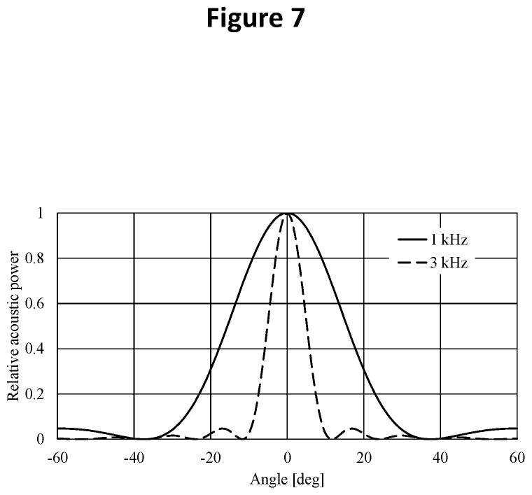

d=D/M (1)

where D is the length of the array, giving a normalised intensity pattern

$$\frac{I ( θ )}{{I}_{0}} = \frac{1}{{M}^{2}} \frac{{sin}^{2} ( \frac{1}{2} k D sin θ )}{{sin}^{2} ( \frac{1}{2 M} k D sin θ )} \qquad ( 2 )$$

where k is the wavenumber. The KSN1005A speakers are not omnidirectional, but have an angular response, which changes little over the beam-widths. FIG. 7 shows the intensity pattern for M=7, d=0.08 m, f=1 kHz and 3 kHz, and sound speed c=340 m s⁻¹. The half-power half beam-width is c/(2Mfd), or 17° at 1 kHz.

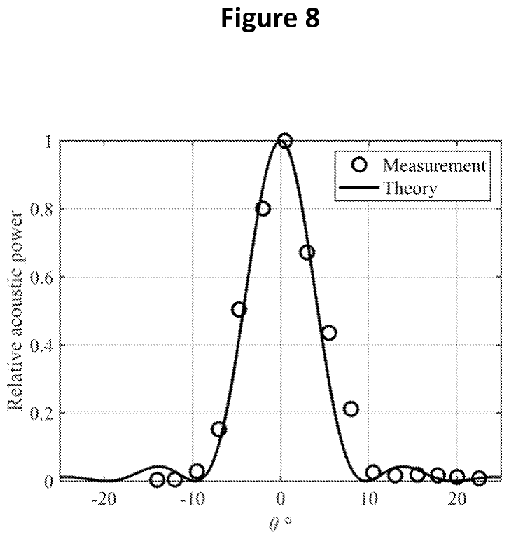

The experiment completed evaluated the design in the laboratory environment over the frequency range of 0.5 kHz to 4 kHz in 100 Hz steps, and with time delays between array elements giving peaks shifts of 0°, ±30°, ±45°, and ±60°. The angle of sound wave propagation for the phased array can be altered directly from the code. Thirty-six frequencies, seven delays, and measurements at sixteen microphone positions were conducted. One hundred measurements were taken on average for each of these configurations. FIG. 8 shows an example of the results for these tests.

There are some variations between theory and measurement around the central beam lobe, and larger variations at larger angles. These are most likely due to small variations in speaker gain across the seven speakers. This was optimized by the equalization of the gains for all speakers in the final configuration.

### EXAMPLE 4

In this example, the reflectivity from soil and water was further examined.

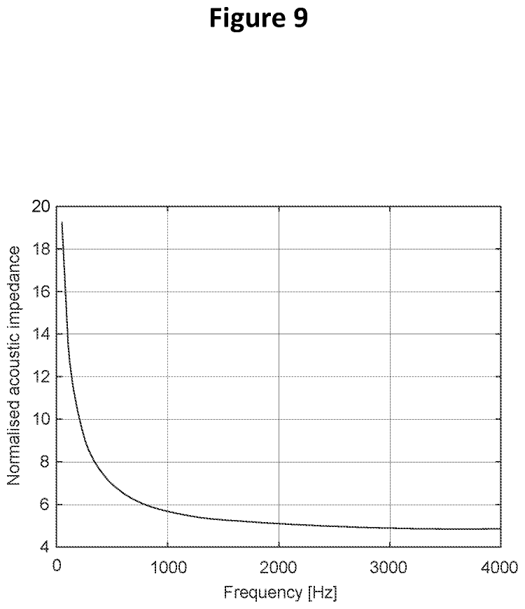

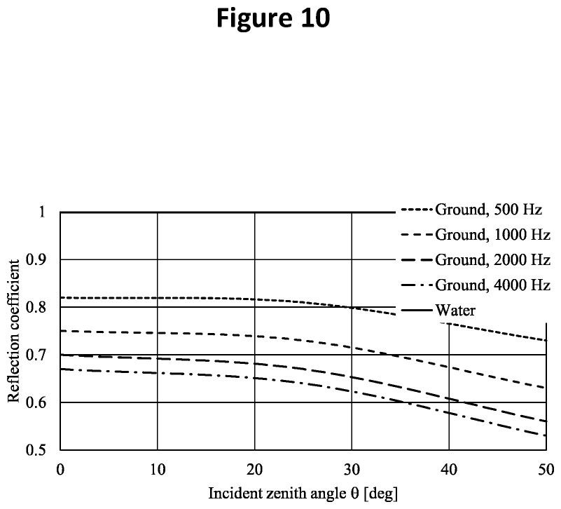

Reflectivity from soil can be estimated by Attenborough's 4-parameter model for the acoustic impedance of a ground surface. Typical values of the model's parameters are soil porosity=0.3, soil tortuosity=1.35, flow resistivity=10-103 kPa s m-2, and pore shape factor ratio=0.75. Results from trials completed are shown in FIG. 9 and FIG. 10, using these values.

The greatest frequency variation between water and soil in impedance occurs at low frequencies (FIG. 9). However, the highest contrast between a water surface (which is generally considered to have a reflectivity of 1) and a soil surface is at higher frequencies (FIG. 10). Given the generally sharper beam at higher frequencies, and the better soil-water contrast at higher frequencies, the optimum operating frequency was selected in a range from to 2 to 4 kHz.

### EXAMPLE 5

Laboratory based examples were further tested.

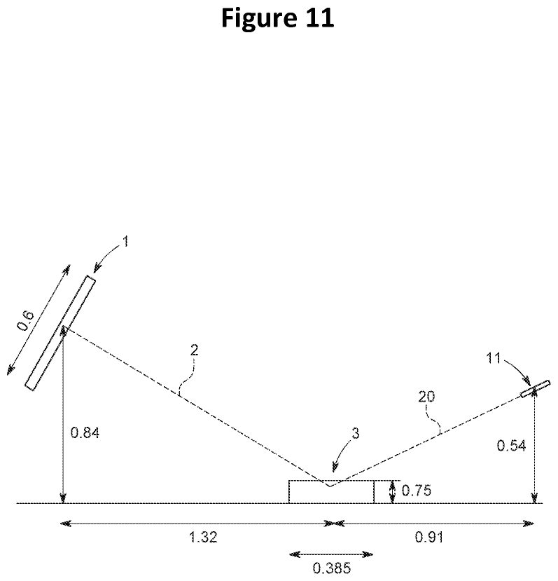

The preliminary experiments were designed to determine how different soil water contents affected the amplitude of the acoustic signal. The laboratory set up for these experiments is shown in FIG. 11.

The acoustic sensor consists of the phased acoustic transmitting array 1 transmitting sound in direction 2 and the reflected sound form the ground surface 3 is shown by arrow 20 which was received by an omnidirectional microphone 11. The sample trays (ground surface equivalent 3) measured 0.385 m by 0.285 m with the height of dry soil being 0.75 m above the laboratory floor. The dry soil mass was 8.4 kg and estimated soil dry bulk density used for these tests was 1.02 kg m-3. The signal amplitudes were recorded for a dry soil, and wet soil with 1 L, 2 L of water added to the sample tray and an over saturated soil (3 L of water added) conditions. The latter sample showed free water covering the soil surface. Soil with added water samples were allowed to equilibrate for at least 24 hours under a plastic cover to prevent slow evaporation.

The laboratory experiments were carried out in an anechoic chamber and experimental code to control the acoustic system was created.

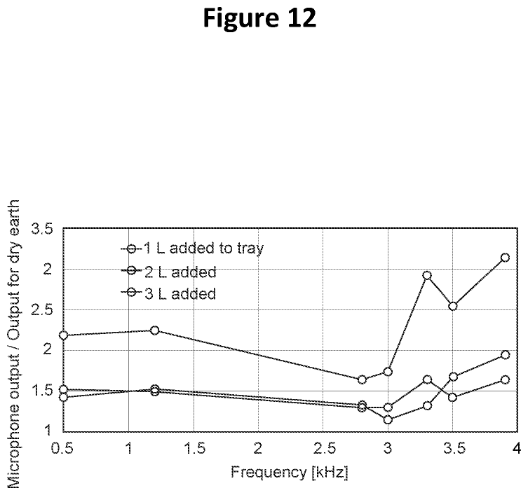

Initial tests were conducted in order to determine whether there is a change in signal strength when the soil becomes saturated and pooling of surface water begins and to what extent. The definition of ‘saturated’ and ‘pooling’ refers to the visually observed surface water in a tray. Measurements were conducted on a dry soil, and with 1, 2, and 3 L of water added to the sample tray while the acoustic array angle was locked at 45 degrees. The results of these measurements are shown in FIG. 12.

Multiple runs were performed over each sample and at each frequency and an averaged result plotted on FIG. 12. The errors of these measurements were not plotted because they were within the size of data points for each measurement. The 1 and 2 L cases give very similar amplitude reflectivity values. All measurements on wetted soil show relative acoustic power around 50% higher than for dry soil measurements and the relative acoustic power for 3 L added water dramatically increased compared to the 1 and 2 L water added to the dry soil. In addition, these measurements showed that variability increased above a frequency of about 3 kHz. The variability above 3 kHz is most likely due to some direct sound combining destructively and constructively with the reflected sound.

### EXAMPLE 6

In this example, a further field test was completed.

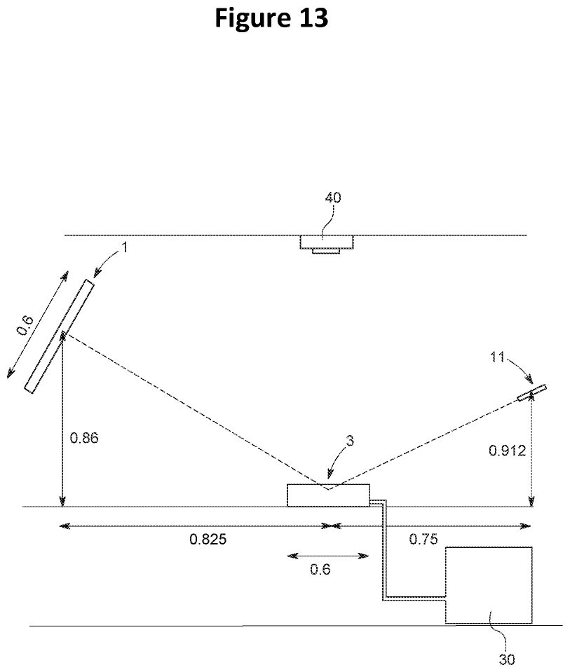

The test geometry shown in FIG. 13 comprised the speaker array 1 mounted on a tripod and angled at 45° and at the height of the single microphone 11, which was also on a tripod. Between the two, near the ground 3, a soil-filled pan with dimensions 0.6×0.44 m was placed. This pan was set up with a manometer 30 so that water level could be continuously varied. On a frame above these items a downward facing 3D structured light camera 40 viewed the earth-filled tray, so that its topology could be recorded, including any pooled water. To one side of the array-microphone line a camera also recorded the surface conditions in the tray.

Sinusoidal pulses of various frequencies and of 10 ms duration were generated and directed toward the soil-filled pan. There are multiple paths to the microphone from each of the seven speakers: directly across the space between speaker and microphone; and bouncing off the soil and surrounding platform and then back upward to the microphone. Acoustic foam placed around the edges of the soil-filled pan helped to reduce the unwanted reflections from the platform.

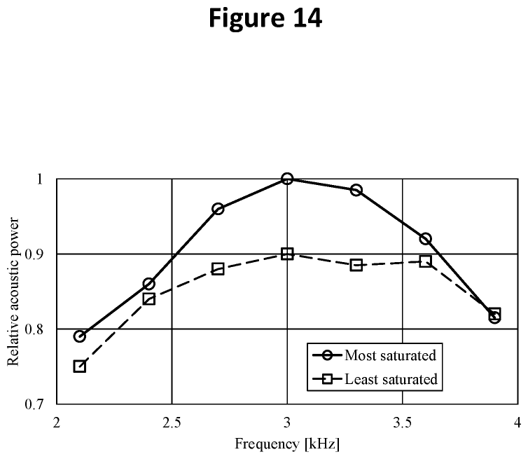

In these experiments, all soil samples were initially wet. The “most saturated” example had water ponded on the surface. FIG. 14 shows that, over a range of frequencies centred on ˜3 kHz, there was a clear and consistent demarcation between the ponded water condition and the soil surface condition of wet but not ponded.

The field experiment showed that the basic setup worked outside of the acoustically-controlled laboratory environment. There was a good separation between a soil surface that was merely wet and a surface that was ponded.

### EXAMPLE 7

Another field test was completed in this example.

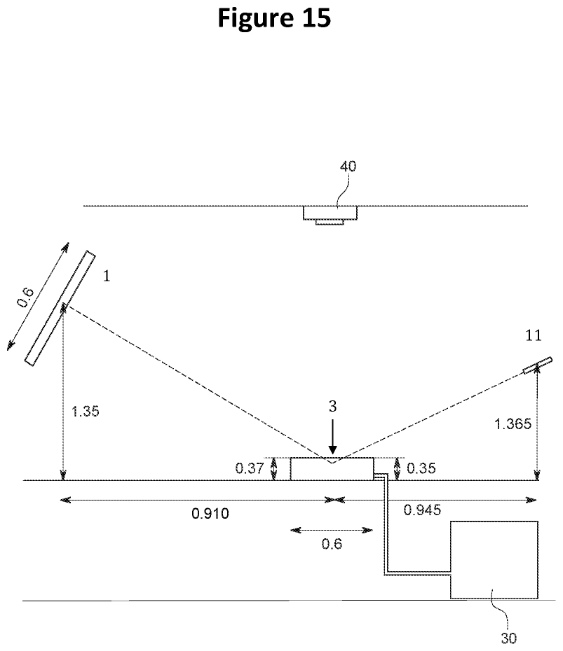

The acoustic reflectivity experimental procedures during this field test were carried out in a similar way to the test above in Example 6. The dimensions and respective distances are indicated in FIG. 15 using a similar set up to FIG. 13 described above. The main difference was in the acoustic signal codes used during this experiment. This time a 13-step Barker code and a two-tone signal were tested on a range of soil conditions in order to increase acoustic sensor performance and tolerance towards environmental sources of noise. Acoustic reflectivity measurements were done for a range of surface wetting conditions (controlled using the manometer), and for frequencies 2.5 kHz-4.5 kHz with a 0.4 kHz step. Both a tonal pulse, and a 13-step Barker phase-encoded pulse were evaluated. The Barker code was found to give clearer signals.

The 3.3 kHz frequency consistently gave the greatest amplitudes, most likely due to the efficiency of the speakers being high at this frequency (note that the microphone response is flat with frequency). The set up was also tested on a soil sample when it was covered with short grass and it was found grass and its roots in the soil had no clear effect on measured signals during these experiments.

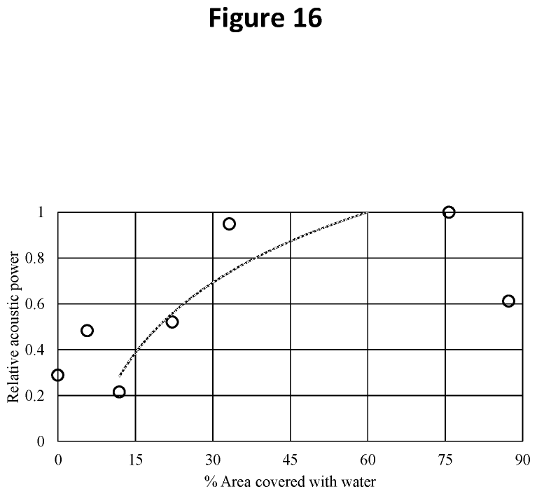

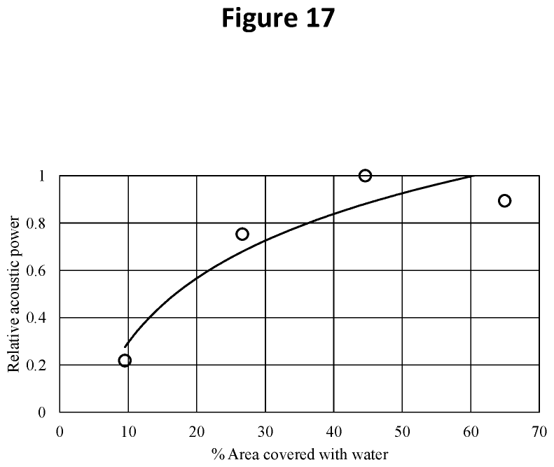

FIGS. 16 and 17 are characteristic of these results and the errors of these measurements were not plotted because they were within the size of data points for each measurement. FIG. 16 demonstrates changes of the relative acoustic power when the soil tray was slowly filled in with water, and shows changes as more and more of the soil surface depressions became filled with water over time. During this experiment, the measurements were progressively done from dry soil to the state where all the soil surface depressions were connected and filled with water.

There is a similar variation in measured relative acoustic power at all frequencies. Here the percentage of the tray covered in free water is compared with the relative acoustic power. There is a very clear increase in acoustic output up to a free water coverage of 40%, and some indication that the amplitude falls off at very high-water coverage. A 13-step Barker code gave best results with respect to signal-to-noise ratios. The trends shown in FIGS. 16 and 17 are reproducible and similar for both experiments. FIG. 17 is lacking the data points for the conditions from 0 to ˜10% and ˜90% of soil area covered with water, as during the second experiment, the soil absorbed some water and was wet, while in the first experiment it was initially dry.

### EXAMPLE 8

In this example, effect of pasture cover on acoustic reflectivity was examined.

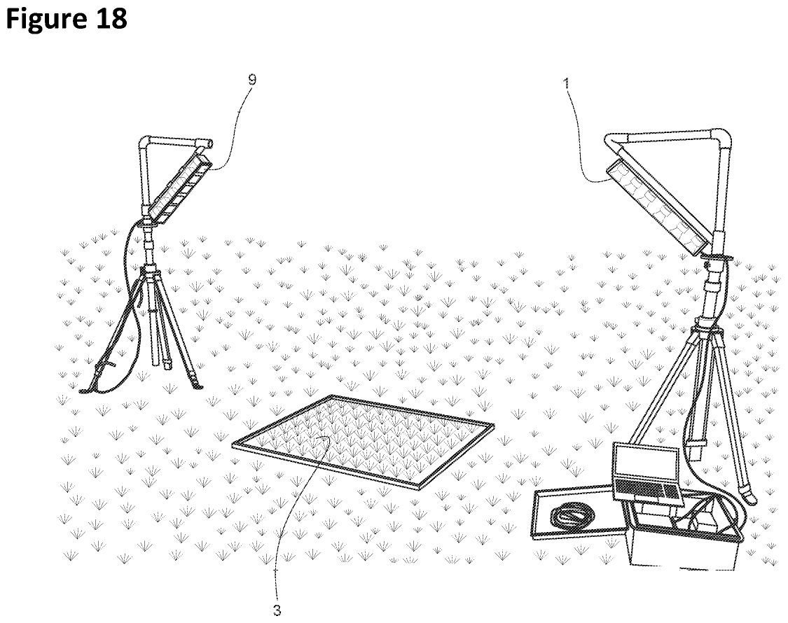

The ground reflectance is known to depend on pasture biomass. In order to evaluate the dependence of reflectivity on pasture biomass, the speaker and microphone arrays were mounted above four different areas of pasture having different biomass. The field set up for these experiments is shown in FIG. 18 using an emitter array 1, microphone array 9 and a target area of soil/pasture 3. For each area, acoustic reflectivity measurements for frequencies 2.5 kHz-4.5 kHz with a 0.4 kHz step were conducted over uncut pasture and pasture cut to close to the ground. A 13-step Barker code was used as it gave best results with respect to signal-to-noise ratios in our previous experiments. The biomass dry matter was measured by collecting the cut pasture, drying it and weighing.

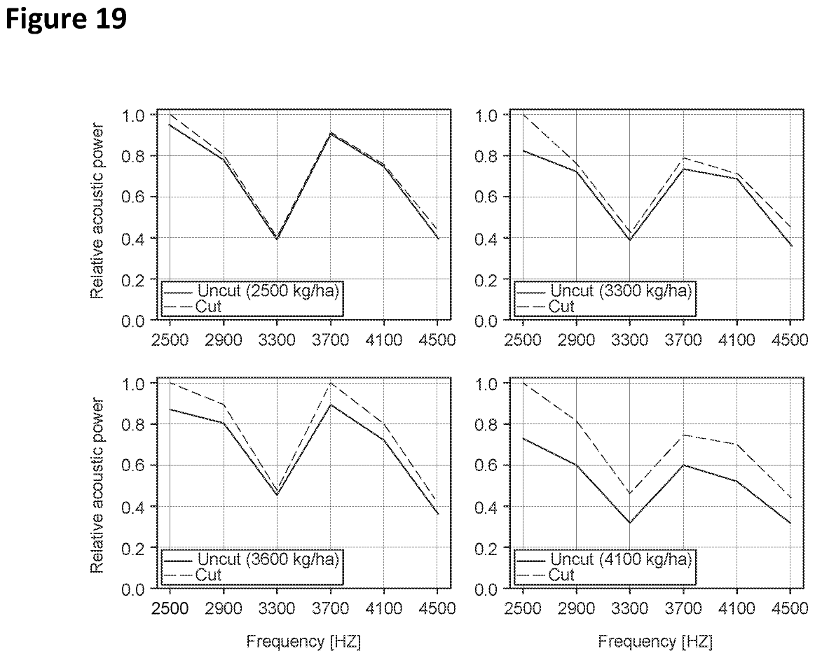

FIG. 19 shows that pasture canopy up to a biomass of around 3500 kg dry matter/ha has no clear effect on measured signals. Based on these results, it can be concluded that our previous approach (Example 7) can reliably be used to detect formation of free water beneath pasture biomass of up to ˜3500 kg dry matter/ha.

### EXAMPLE 9

In this example, we examined whether the acoustic reflection can be used to sense the onset of free dairy shed effluent on the ground surface.

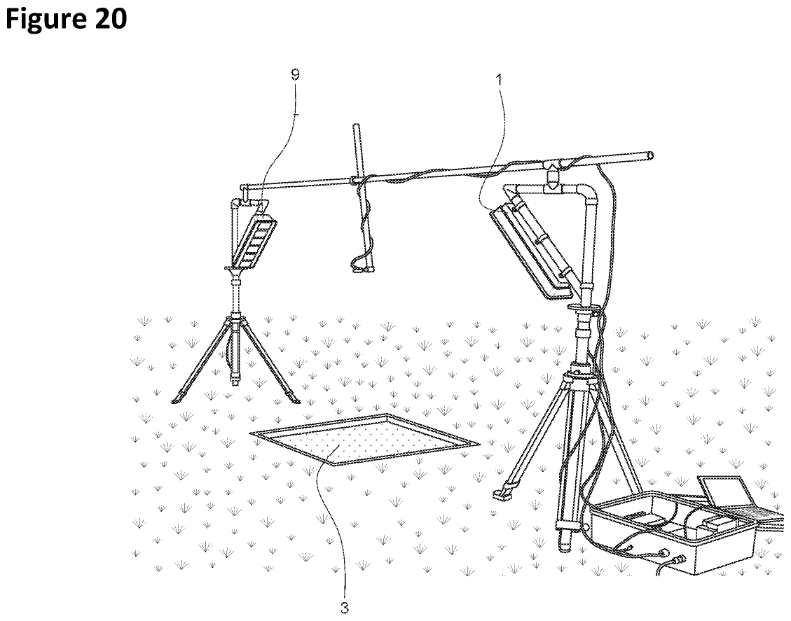

The experiment was designed to investigate how different effluent coverage affected the amplitude of the acoustic signal. The field set up for this experiment was shown in FIG. 20. The set up comprised the speaker 1 and microphone 9 arrays, both mounted at 45° above a bounded runoff plot (1 m×1 m) 3. A downward facing 3D structured light camera viewed the bounded runoff plot, so that its topology could be recorded, including any pooled effluent. Acoustic reflectivity measurements, using a 13-step Barker code, were done for frequencies 2.5 kHz-4.5 kHz with a 0.4 kHz step. The measurements were progressively done from soil surface with empty depressions to the state where all the soil surface depressions were completely filled with effluent

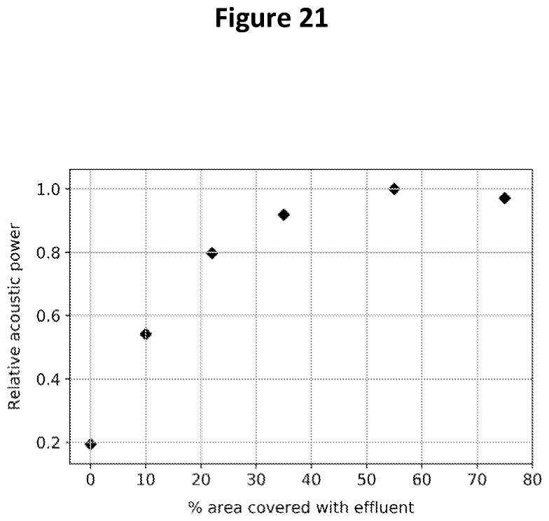

There is a similar variation in measured relative acoustic power at all frequencies to surface coverage with effluent. FIG. 21 shows changes of the amplitude of the reflected signal for 3.3 kHz frequency when the runoff plot was slowly filled in with effluent. There is a very clear increase in acoustic output up to a free effluent coverage of ˜40%, and some indications that the amplitude falls off at very high effluent coverage. Based on these results, the acoustic reflection can be used to detect the onset of free effluent on the ground surface. Moreover, the measured reflectivity pattern for free effluent coverage is comparable to our previous findings for the free water coverage.

The onset of pooling or the formation of free water on the ground surface may be detected in an irrigation setting by assessment of the reflected acoustic signal. Based on the applicant's work, the acoustic response is reliable for measurements of the soil surface area covered with water in a range from 10% to 80%.

Further, the presence of grass does not confound the results.

Pooled water may be detected by one or more of: assessment of reflected signal amplitude; assessment of reflected signal amplitude compared to predictions from an acoustic reflection model; assessment of reflected signal amplitude changes over time; and assessment of changes in the relative amplitude of reflected signals at multiple frequencies

Further information in the reflected signal may be assessed in addition to or instead of amplitude. For example, one or more of the following may be assessed: the phase of the reflected signal, the phase of the reflected signal compared to a predictions from an acoustic reflection model; assessment of changes in the phase of the reflected signal over time; and changes in the relative phase of reflected signals at multiple frequencies.

Further, the above assessments may be made at a single frequency, or at several frequencies, or over a range of frequencies. Reflectance of the soil surface is frequency-dependent. This may therefore provide more robust sensing of the fraction of pooled water can result from transmitting at multiple frequencies.

The system may also detect changes in angular properties of reflection. The ground surface is typically rough and a diffuse scatterer of sound. In contrast, a water surface is mirror-like. The use of a plurality of, or multiple transmitted and/or received angles allows for further ground/water discrimination.

The system may compare data from the reflectance sensors with surface models. Any suitable theoretical or empirical acoustic reflection model may be used. Acoustic reflection models may be built based on data from experiments with known ground surface conditions. Further, acoustic reflection models may be adapted based on data, by any suitable method including self-learning methods. Field measurements may be supported by a virtual testing environment based on 3-D hydraulic modelling. An emulator of the sensor system may be based on measurements as well as the acoustic and hydraulic models. This emulator may accelerate the learning of the process control system. 3-D descriptions of soils and water movement may be adapted for simulating the behaviour of water on the soil surface, the temporal and spatial dynamics of free water and the triggering of bypass flow and runoff.

The system may use a predictive algorithm to control an irrigation system and prevent free water from developing. The algorithm may be self-learning by continually receiving information from the acoustic sensors to improve the algorithm so that its predictive accuracy increases over time.

The system may be adapted to correct for external factors such as background interference (primarily acoustic), changes in pasture biomass and spatial/temporal variation in the testing conditions.

In general, the Applicant's system may take any appropriate irrigation control decision based on the acoustic reflectance data. For example, the system may act to reduce or turn off water application immediately or after an appropriate time delay. Decisions may be made based on the sensing of the onset of water pooling, the onset of free water flow, when the reflectance exceeds a threshold, or by comparison to acoustic or hydraulic models.

Irrigation control decisions may be made in real-time. For example, water application rates may be adjusted based on the current ground surface conditions measured by the acoustic sensing arrangement.

In addition to acoustic data, other sources of data may also be used—for example, existing moisture sensors, in-ground moisture sensors, weather data or sensors etc, positioning systems (e.g. GPS), existing soil property information, soil maps, irrigation maps, grazing records, prior assessments of pasture or crop production, existing data or measurements of surface topography, and/or data on the configuration of the irrigation system. Historical information may also be used, such as information on an amount of water historically applied to a particular area and the previous acoustic and hydraulic properties of the area.

If the irrigation system is variable rate (i.e. able to control valves and/or sprinklers to provide a spatially variable rate of water application) then the acoustic information may be used in variable rate determination.

The system may be used in any appropriate irrigation system for agricultural or horticultural applications, including moving irrigators (e.g. centre-pivot irrigators), movable irrigators such as side-roll irrigators and fixed irrigators. The system may also be used, (not attached to an irrigator), to record the presence or absence of free water, whether or not arising from irrigation. For example, the system may be used for industrial or environmental applications to monitor liquid presence e.g. the presence of a contaminant spill. E.g. spills to surrounding areas beyond an effluent or sewage treatment pond, spills around chemical storage areas and so on.

While the present invention has been illustrated by the description of the embodiments thereof, and while the embodiments have been described in detail, it is not the intention of the Applicant to restrict or in any way limit the scope of the appended claims to such detail. Further, the above embodiments may be implemented individually, or may be combined where compatible. Additional advantages and modifications, including combinations of the above embodiments, will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. An irrigation control system including:
a sound emitter arranged to emit sound towards a ground surface;
a sound receiver arranged to receive sound emitted by the sound emitter and reflected or scattered from the ground surface; and
a controller configured to control one or more irrigation parameters of an irrigator based at least in part on sound received by the sound receiver.

2. An irrigation control system as claimed in claim 1 wherein the sound emitter is a directional sound emitter, arranged to emit a directional sound beam.

3. An irrigation control system as claimed in claim 2 wherein the directional sound emitter is arranged to emit a sound beam with a half power beam width in the range 4 to 60 degrees.

4. An irrigation control system as claimed in claim 2 wherein the directional sound emitter is arranged to emit a sound beam with a half power beam width around 8 to 45 degrees.

5. An irrigation control system as claimed in claim 2 wherein the directional sound emitter is arranged to emit a sound beam having a projected area at the ground surface in the range 0.03 to 1.8 square metres.

6. An irrigation control system as claimed in claim 2 wherein the directional sound emitter is arranged to emit a sound beam having a projected area at the ground surface of around 0.2 square metres.

7. An irrigation control system as claimed in any one of claims 2 to 6 wherein the directional sound emitter includes an array of sound emitting elements.

8. An irrigation control system as claimed in any one of claims 2 to 7 wherein a direction of the directional sound beam is controllable.

9. An irrigation control system as claimed in claim 8 wherein the directional sound emitter includes a controllable phased array of sound emitting elements.

10. An irrigation control system as claimed in any preceding claim wherein the sound emitter is configured to emit sound with a frequency in the range 0.5 to 4.5 kHz.

11. An irrigation control system as claimed in claim 10 wherein the sound emitter is configured to emit sound with a frequency around 2 to 4.5 kHz.

12. An irrigation control system as claimed in any preceding claim wherein the sound emitter is configured to emit sound in the form of sound pulses.

13. An irrigation control system as claimed in claim 12 wherein the sound emitter is configured to emit sound in the form of sound pulses with a pulse duration in the range 0.5 to 10 ms.

14. An irrigation control system as claimed in claim 13 wherein the sound emitter is configured to emit sound in the form of sound pulses with a pulse duration of around 1 ms.

15. An irrigation control system as claimed in any preceding claim wherein the sound emitter is configured to emit sound embodying a coded signal.

16. An irrigation control system as claimed in any preceding claim wherein the sound receiver is a microphone.

17. An irrigation control system as claimed in any preceding claim wherein the sound receiver is a microphone array.

18. An irrigation control system as claimed in claim 17 wherein the sound receiver is a directional microphone array.

19. An irrigation control system as claimed in claim 18 wherein the sound receiver is a microphone phased array having a controllable sensing direction.

20. An irrigation control system as claimed in any preceding claim wherein the controller is configured to control the one or more irrigation parameters to reduce or prevent water application when the sound received by the sound receiver is indicative of the presence of surface water.

21. An irrigation control system as claimed in any preceding claim wherein the controller is configured to control the one or more irrigation parameters to reduce or prevent water application when a change in the sound received by the sound receiver is indicative of the onset of the presence of surface water.

22. An irrigation control system as claimed in any preceding claim, wherein the one or more irrigation parameters include a water application rate.

23. An irrigation control system as claimed in any preceding claim, wherein the one or more irrigation parameters include valve on/off status.

24. An irrigation control system as claimed in any preceding claim, wherein the one or more irrigation parameters include valve pulsing and/or valve pulse rate.

25. An irrigation control system as claimed in any preceding claim, wherein the one or more irrigation parameters include varying irrigation boom speed and/or varying irrigation intensity.

26. An irrigation control system as claimed in any preceding claim, including a positioning system configured to determine a position of the irrigator in real time.

27. An irrigation control system as claimed in any preceding claim, configured for continuous or periodic emission and detection of sound.

28. An irrigation system including an irrigation control system as claimed in any preceding claim and one or more irrigators arranged to supply water to the ground surface.

29. An irrigation system as claimed in claim 28 wherein the one or more irrigators include one or more moving irrigators.

30. An irrigation system as claimed in claim 29 wherein the sound emitter and sound receiver are mounted on the moving irrigator.

31. An irrigation system as claimed in any one of claims 28 to 30, wherein the controller is configured to control the one or more irrigation parameters of the one or more irrigators based, at least in part, on sound received by the sound receiver in real time.

32. An irrigation system as claimed in any one of the above claims wherein the water is selected from:
fresh water, grey water, water used in agriculture, irrigation sources, effluent and other substantially water-based streams capable of irrigation or broadcast to the ground.

33. A method of controlling an irrigation system including:
emitting sound towards a ground surface;
receiving sound emitted by the sound emitter and reflected or scattered from the ground surface; and
controlling one or more irrigation parameters of an irrigator based at least in part on sound received by the sound receiver.

34. An irrigation control system including:
a sensor arrangement configured to sense the onset of surface water pooling or, the onset of free water flow on the ground surface; and
a controller configured to control one or more irrigation parameters of an irrigator to reduce application of water in response to the sensing of the onset of surface water pooling or, the onset of free water flow on the ground surface.
